(19) United States
(12) Patent Application Publication
(10) Pub. No.: US 2025/0339928 A1
(43) Pub. Date: Nov. 6, 2025

(54) SYSTEM AND PROCESS FOR SEPARATING MATERIALS FROM SKIDS AND PALLETS

(71) Applicant: Komar Industries, LLC, Groveport, OH (US)

(72) Inventors: Mark E. Koenig, Carroll, OH (US); Douglas C. Vanderlinden, Oakville (CA)

(21) Appl. No.: 19/198,947

(22) Filed: May 5, 2025

Related U.S. Application Data
(60) Provisional application No. 63/642,347, filed on May 3, 2024.

(51) Int. Cl. B23P 19/04; G01N 23/083; G01N 23/10

(52) U.S. Cl. CPC B23P 19/041; G01N 23/083; G01N 23/10

(57) ABSTRACT

A system for separating a cardboard box or other material from a skid, pallet, or the like. The system comprises a support surface adapted to receive a skid, pallet, or the like on which a cardboard box or other material is secured. A ram is positioned adjacent to the support surface, which is adapted to separate a cardboard box or other material from a skid, pallet, or the like that is positioned on the support surface. A processing system, such as an auger system, is adapted to receive and process a cardboard box or other material that has been separated from a skid, pallet, or the like by the ram.

This application claims the priority benefit of U.S. Provisional Application No. 63/642,347, filed May 3, 2024, which is hereby incorporated by reference.

### BACKGROUND AND SUMMARY OF THE INVENTION

Exemplary embodiments of the present invention relate generally to material processing systems and processes.

Such as shown in FIG. 1, facilities, especially large industrial entities, receive significant amounts of material and components on wooden skids, often with cardboard boxes stapled or nailed to the skid or pallet to prevent movement during transit. Once the material and components are removed, the customer must dispose of the skid or pallet and the attached box. Growing recycling initiatives and increasing sustainability targets are causing the industrial entities to attempt to recycle both the wooden skid or pallet and the cardboard upper box.

Recycling requires physical separation of the cardboard stapled to the wooden skid or pallet. Entities expend significant labor to manually remove the cardboard using pry bars (see FIG. 2), hand-held saws, and other manual methods. The process is very expensive and also potentially exposes an entity to injury and compensation claims. Once the cardboard has been manually removed from the skid or pallet, the individual skids or pallets must then be manually stacked to later undergo further processing. The removed cardboard must also be manually transferred onto a conveyor and directed to an auger compactor, ram compactor, or a baler for further processing.

In view of the shortcomings of the known art, there is a need to improve the separation of a box or other materials from a skid or pallet, preferably from one or more of cost, speed, efficiency, and safety standpoints. Exemplary embodiments of the present invention include systems and processes adapted to satisfy at least one of the aforementioned needs. In one exemplary embodiment, a system is provided for separating a cardboard box from a skid, pallet, or the like. The system comprises a support surface that is adapted to receive a skid, pallet, or the like on which a cardboard box is secured. A ram is positioned adjacent to the support surface, wherein the ram is adapted to separate a cardboard box from a skid, pallet, or the like that is positioned on the support surface. A processing system is then adapted to receive and process a cardboard box that has been separated from a skid, pallet, or the like by the ram.

An exemplary embodiment of the support surface is configured to keep a skid, pallet, or the like in position on the support surface when the ram separates a cardboard box. For example, one embodiment of the support surface has at least one raised edge to keep a skid, pallet, or the like in position on the support surface when the ram separates a cardboard box.

In an exemplary embodiment, the ram is hydraulic. While hydraulic power is preferred, other exemplary embodiments may implement another suitable source of power for a ram.

An exemplary embodiment of a system may further comprise a cover through which a separated cardboard box is adapted pass before being received by the processing system.

An exemplary embodiment of a system may also further comprise a scanning system adapted to sense metal materials or batteries in or on a cardboard box and/or an associated skid, pallet, or the like. An exemplary embodiment of a scanning system is adapted to facilitate stoppage of the system to allow for removal of metal materials or batteries sensed by the scanning system. One example of a scanning system is an x-ray system. Other exemplary embodiments may comprise another suitable type of scanning system.

In one example of a system comprising a cover and a scanning system as previously described, the scanning system may be secured to the cover. Other exemplary embodiments may have a scanning system in another suitable location that facilitates scanning of the cardboard boxes or other material. For example, scanning may take place at any point in the operation of an exemplary embodiment of a system.

Another exemplary embodiment of a system may further comprise a ram home sensor adapted to sense that the ram is back in a home position after separating a cardboard box from a skid, pallet, or the like. In one example having a ram home sensor, a support surface is associated with a plate, wherein the plate is adapted to rotate downward to eject a skid, pallet, or the like when the ram home sensor senses that the ram is back in the home position after separating a cardboard box from the skid, pallet, or the like. In another example having a ram home sensor, a support surface is associated with a conveyor system, wherein the conveyor system is adapted to convey a skid, pallet, or the like such that the skid, pallet, or the like is ejected when the ram home sensor senses that the ram is back in the home position after separating a cardboard box from the skid, pallet, or the like. A conveyor system is a roller system in one exemplary embodiment, and is preferably powered and automatic.

In yet another exemplary embodiment having a ram home sensor, a support surface is associated with an autostacker (also referred to as an automated stacker), wherein the autostacker is adapted to collect a skid, pallet, or the like when the ram home sensor senses that the ram is back in the home position after separating a cardboard box from the skid, pallet, or the like, and the autostacker is further adapted to stack multiple skids, pallets, or the like that have been collected. An exemplary embodiment of an autostacker may be partially or fully automatic. Some other exemplary embodiments may comprise a skid or pallet stacker (or the like) that is manually operated.

A preferred embodiment of a processing system is an auger system. Other exemplary embodiments of a processing system may utilize another suitable type of processing system, including, but not limited to, a ram system, a compactor (e.g., auger or ram) system, a conveyor system, a shredder system, a baling system, etc.

In addition to the novel features and advantages mentioned above, other benefits will be readily apparent from the following descriptions of the drawings and exemplary embodiments.

### BRIEF DESCRIPTION OF THE DRAWINGS

FIG. 1 is an example of a known manner of mounting a cardboard Gaylord box on a pallet.

FIG. 2 is an example depicting a known manual method of the use of a pry bar to achieve separation of the cardboard Gaylord box of FIG. 1 from the pallet.

FIG. 3 is a top plan view of an exemplary embodiment of a system for separating materials from a pallet, skid, or the like.

FIG. 4 is a side elevation view of the system of FIG. 3.

FIG. 5 is a top plan view of an exemplary embodiment of a system for separating materials from a pallet, skid, or the like.

FIG. 6 is a side elevation view of the system of FIG. 5.

FIG. 7 is an end elevation view of an exemplary embodiment of a system for separating materials from a pallet, skid, or the like, wherein the system comprises an automated stacker. A processing system for a box or other material is not shown for ease of reference.

FIG. 8 is an end elevation view of an exemplary embodiment of a system for separating materials from a pallet, skid, or the like, wherein the system comprises a rotatable ejection plate. A processing system for a box or other material is not shown for ease of reference.

FIG. 9 is an end elevation view of an exemplary embodiment of a system for separating materials from a pallet, skid, or the like, wherein the system comprises a powered roller conveyor. A processing system for a box or other material is not shown for ease of reference.

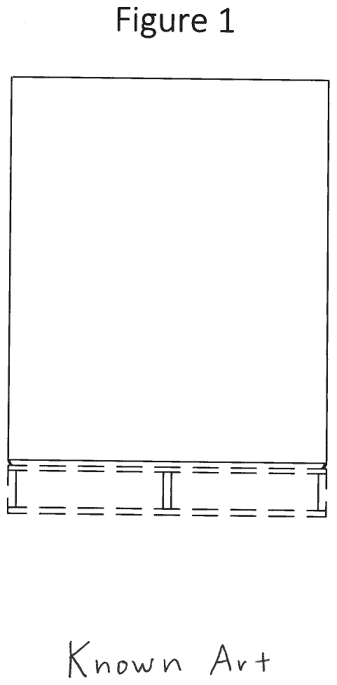

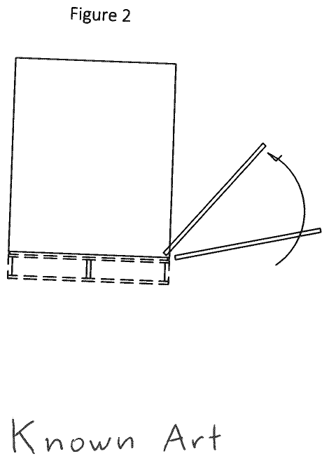

### DETAILED DESCRIPTION OF EXEMPLARY EMBODIMENT(S)

Exemplary embodiments of the present invention are directed to systems and processes for separating boxes or other materials from pallet or skids.

FIG. 3 shows an exemplary embodiment of a system 10 adapted to separate boxes or other materials from pallets, skids, or the like (hereafter, pallets, skids, and other similar apparatuses shall collectively be referred to as skids for ease of reference). This example of system 10 comprises a support surface 12 on which an operator may place a skid 14 that has a box A or other material secured thereto. In this exemplary embodiment, support surface 12 is configured to keep a skid 14 in position on support surface 12 during operation of system 10, which is discussed further below. For example, one embodiment of support surface 12 has at least one raised edge (see 16A and 16B) to keep skid 14 in position on support surface 12 during operation of system 10. More particularly, one example of support surface 12 may be a substantially fixed placement holder for a skid.

In an exemplary operation, after the skid 14 is placed on support surface 12, a forklift B may depart to allow for further processing of the skid 14 (and box A or other material). In an exemplary embodiment, system 10 comprises at least one sensor 18 that is adapted to sense the presence of box A (or other material) and/or the skid 14 on support surface 12. At least one sensor 18 may have any suitable position to sense the presence of box A (or other material) and/or the skid 14 on support surface 12.

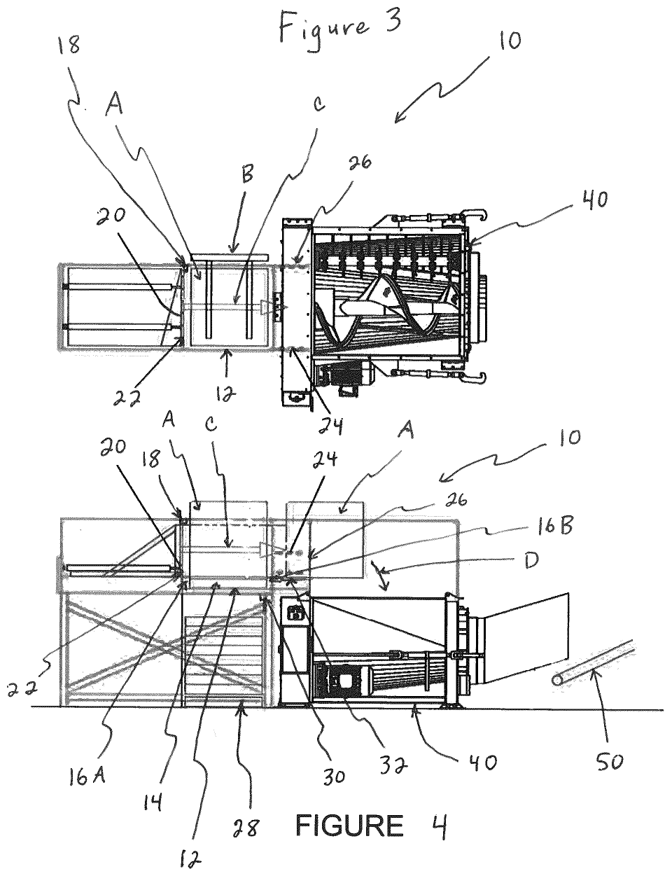

System 10 comprises a ram 20 adjacent to support surface 12 that is adapted to separate cardboard box A from skid 14. In this example, when box A and/or skid 14 are sensed, ram 20 is adapted to automatically sweep across or adjacent to skid 14 (see representative arrow C), with dogs 22 that are adapted to partially penetrate box A or other material to grip it. In an exemplary embodiment, system 10 (more particularly ram 20) fully sweeps across skid 14 and removes the cardboard box A or other material from skid 14, and then fully retracts to a home position. An exemplary home position is shown in FIGS. 3 and 4.

In an exemplary embodiment, anti-drag grab dogs 24 may be adapted to further help to keep skid 14 in place and/or to help prevent a separated box A from being pulled backwards when ram 20 retracts. In this exemplary embodiment, anti-grab dogs 24 are provided on a cover 26 through which a separated cardboard box A is adapted pass before being received by a further processing system. In an exemplary embodiment, cover 26 may be adapted to serve a safety function.

Once the sweep is completed in this exemplary embodiment, system 10 transfers skid 14 onto a stacker section 28. Such as in this embodiment, an example of stacker section 28 is located under support surface 12 such that system 10 is adapted to drop or otherwise transfer skid 14 onto stacker section 28. In an exemplary embodiment, a sensor/sensing system 30 is adapted to locate the height of the skids on stacker section 28, and alert an operator to remove the stack of skids when it is full. A sensor/sensing system 30 may have any suitable position to sense the height of the stack. Also, in other exemplary embodiments, the stacker 28 may be substituted with a roller conveyor or sliding chute if, for example, the user is processing a mixture of skids that require physical confirmation to ensure they are recyclable, from both a size and material of construction perspective.

Returning to a separated box A such as representatively depicted in the exemplary embodiment of FIG. 4, the swept cardboard box A or other material is pushed across a separator base 32 and deposited it into a rotary auger unit 40 (see representative arrow D) with a tapered screw design to index the box A and then shear it into pieces and extrude it. While a rotary auger unit such as is available from Komar Industries, LLC is particularly beneficial, some other exemplary embodiments may have another type of equipment for processing the box or other material (e.g., shredders, compactors, rams, etc.). FIG. 4 shows an example when auger unit 40 transfers the material to a conveyor 50, which may then transfer the material for additional processing.

In an exemplary embodiment, the shearing of the cardboard box or other material is adapted to produce a relatively flat sheet or stream in smaller pieces, that can easily be conveyed to, for example, a baler or other downstream processing system, where the flattened and/or reduced size cardboard or other material dramatically speeds up the baling or other downstream process.

However, if the recovered cardboard or other material is not going to be baled or otherwise processed immediately after separation, an exemplary embodiment of a separation system 10 may, for example, be mounted to or otherwise associated with a conveyor system 50, which may convey the material to an elevated auger other downstream processing system, so it indexes to pack directly into a compaction trailer, which can then transfer the material to, for example, a high capacity baling system off-site.

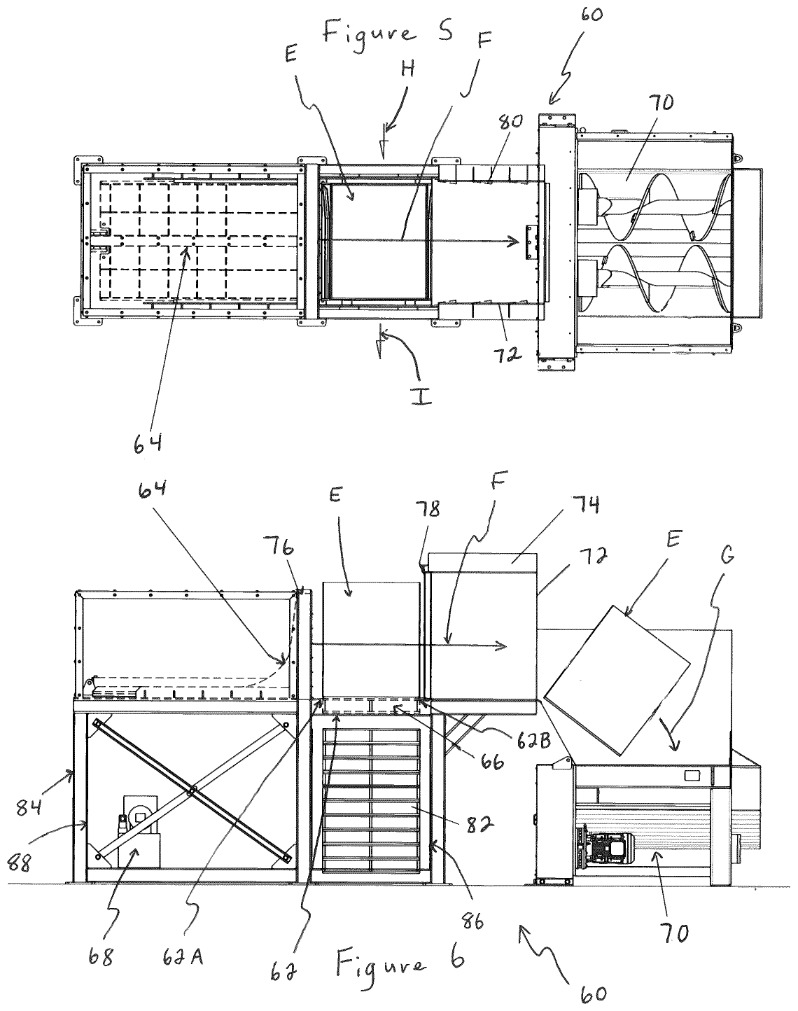

FIGS. 5 and 6 show another exemplary embodiment of a system 60 for separating a box or other material from a skid. System 60 may be similar to system 10. In this exemplary embodiment, system 60 comprises a support surface 62 that is adapted to receive a skid, pallet, or the like (hereafter, pallets, skids, or the like shall again collectively be referred to as skids for ease of reference) on which a cardboard box E or other material is secured. A ram 64 is positioned adjacent to the support surface 62, wherein the ram 64 is adapted to separate a cardboard box E from skid 66 that is positioned on support surface 62. Representative arrow F shows the sweeping motion of this example of ram 64. As represented in FIG. 6, processing system 70 is then adapted to receive (see representative arrow G regarding the motion of box E into processing system 70) and process cardboard box E that has been separated from skid 66 by ram 64.

In this exemplary embodiment, support surface 62 is configured to keep skid 66 in position when ram 64 separates cardboard box E from skid 66. In particular, in this example, support surface 62 has at least one raised edge (see raised edge 62A and raised edge 62B) to keep skid 66 in position on support surface 62 when ram 64 separates cardboard box E. Other exemplary embodiments may have other suitable features to keep a skid in position during the separation process.

In an exemplary embodiment, ram 64 is hydraulic. FIG. 6 shows an example of a hydraulic power source 68. While hydraulic power is preferred, other exemplary embodiments may implement another suitable source of power for a ram.

System 60 may further comprise a cover 72 through which a separated cardboard box E is adapted pass before being received by processing system 70.

This exemplary embodiment of system 60 further comprises a scanning system 74 adapted to sense metal materials or batteries in or on a cardboard box E and/or an associated skid. An exemplary embodiment of a scanning system 74 is adapted to facilitate stoppage of the system 60 to allow for removal of metal materials or batteries sensed by the scanning system 74. One example of a scanning system 74 is an x-ray system. Other exemplary embodiments may comprise another suitable type of scanning sensor.

In particular, in certain instances, a user of the system may have concerns that the combination box and skid may contain metal objects that could damage downstream processing equipment, or may contain lithium batteries which may cause a fire when compressed by an auger compactor, ram compactor, or baler. An exemplary embodiment of a system is designed to optionally incorporate an x-ray or similar detector as the cardboard box is being discharge, to sense the presence of metallic solid objects or batteries. Once detected the system would stop and alarm the user to inspect the container or skid for non-processable items.

In this example of system 60, scanning system 74 is secured to cover 72. Other exemplary embodiments may have a scanning system in another suitable location that facilitates scanning of the cardboard boxes or other material. For example, scanning may take place at any point in the operation of an exemplary embodiment of a system.

Similar to system 10, system 60 may further comprise a ram home sensor 76 adapted to sense that ram 64 is back in a home position (as represented in FIGS. 5 and 6) after separating a cardboard box E from skid 66. Ram home sensor 76 may facilitate other processing functions that require the ram 64 to be in a secure position for safety purposes. Also similar to system 10, system 60 comprises a material present sensor 78 that is adapted to sense the presence of box E (or other material) and/or the skid 66 on support surface 62, and anti-drag grab dogs 80 that may be adapted to further help to keep skid 66 in place and/or to help prevent a separated box E from being pulled backwards when ram 64 retracts.

FIG. 5 further shows an exemplary loading direction (see representative arrow H) for skids 66 onto support surface 62 for processing by system 60, and an exemplary direction (see representative arrow I) for removal of stacked skids 82 in this exemplary embodiment after removal of cardboard boxes or other material by system 60. However, unless otherwise noted, other exemplary embodiments may have other suitable loading and/or removal directions that facilitate desired operation.

Similar to system 10, system 60 is positioned on an elevated platform 84 that facilitates the transfer of separated boxes or other material into a processing system such as an auger system. In particular, platform 84 defines support surface 62 and supports at least ram 64, box E, and cover 72, and further defines a space 86 for stacked skids 82, and a space 88 for hydraulic power source 68 or other equipment or control systems. Unless otherwise noted, other exemplary embodiments may utilize a different platform or other support structure that takes into account the end processing system and/or the operating environment.

FIGS. 7-9 show examples of systems for processing skids from which a cardboard box or other material has been separated. FIG. 7 shows another example for stacking skids below the support surface. In this example, a support surface 90 is associated directly or indirectly with an autostacker 92 (also referred to as an automated stacker), wherein the autostacker 92 is adapted to collect a skid 94 when a ram home sensor (as previously described) senses that the ram is back in the home position after separating a cardboard box from the skid 94. The autostacker 92 is further adapted to stack multiple skids that have been collected. An exemplary embodiment of an autostacker 92 may be partially or fully automatic. Some other exemplary embodiments may comprise a stacker that is manually operated. Various embodiments of an automatic or manual stacker are commercially available or may be designed for a particular application.

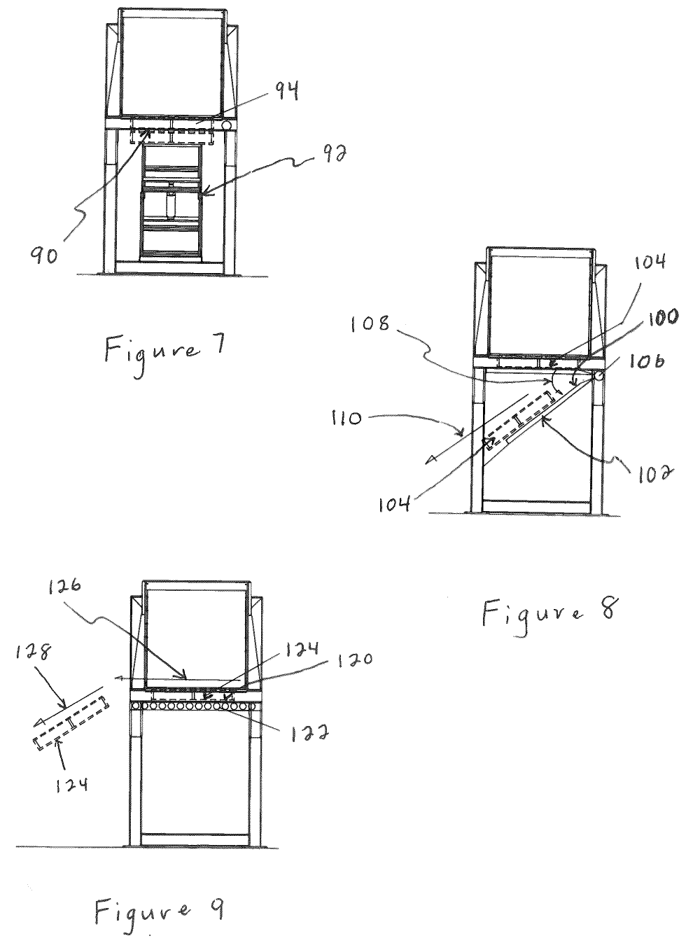

FIG. 8 shows an example in which skids are ejected from a system, respectively, after a cardboard box or other material has been separated. In this embodiment, a support surface 100 is associated directly or indirectly with a plate 102, wherein plate 102 is adapted to rotate downward to eject a skid 104 when a ram home sensor senses that the ram is back in the home position after separating a cardboard box from the skid 104. Plate 102 is associated with a hinge 106 or other rotational mechanism, wherein representative arrow 108 shows the direction of rotation of plate 102 to eject skid 104. In this example, representative arrow 110 indicates the direction of ejection (e.g., such that a skid may be transferred to a conveyor system or other transportation for further processing).

In the exemplary embodiment of FIG. 9, a support surface 120 is associated directly or indirectly with a conveyor system 122. The conveyor system 122 is adapted to convey a skid 124 such that the skid 124 is ejected when a ram home sensor senses that the ram is back in the home position after separating a cardboard box from the skid. In this example, conveyor system 122 is a roller system, which is preferably powered and automatic. However, some embodiments may be manual. Representative arrow 126 shows a direction of conveyance of skid 124 in this exemplary embodiment, wherein representative arrow 128 shows the direction of ejection (e.g., such that a skid may be transferred to a conveyor system or other transportation for further processing).

One preferred embodiment of a processing system is an auger system. However, other exemplary embodiments of a processing system may utilize another suitable type of processing system, including, but not limited to, a ram system, a compactor (e.g., auger or ram) system, a conveyor system, a shredder system, a baling system, etc.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for separating a cardboard box from a skid, pallet, or the like, said system comprising:
a support surface adapted to receive a skid, pallet, or the like on which a cardboard box is secured;
a ram adjacent to said support surface, said ram adapted to separate a cardboard box from a skid, pallet, or the like that is positioned on said support surface; and
a processing system adapted to receive and process a cardboard box that has been separated from a skid, pallet, or the like by said ram.

2. The system of claim 1 wherein said support surface is configured to keep a skid, pallet, or the like in position on said support surface when said ram separates a cardboard box.

3. The system of claim 2 wherein said support surface has at least one raised edge to keep a skid, pallet, or the like in position on said support surface when said ram separates a cardboard box.

4. The system of claim 1 wherein said ram is hydraulic.

5. The system of claim 1 further comprising a cover through which a separated cardboard box is adapted pass before being received by said processing system.

6. The system of claim 1 further comprising a scanning system adapted to sense metal materials or batteries in or on a cardboard box or an associated skid, pallet, or the like.

7. The system of claim 6 wherein said scanning system is adapted to facilitate stoppage of said system to allow for removal of metal materials or batteries sensed by said scanning system.

8. The system of claim 6 wherein said scanning system is an x-ray system.

9. The system of claim 6 further comprising:
a cover through which a separated cardboard box is adapted pass before being received by said processing system;
wherein said scanning system is secured to said cover.

10. The system of claim 1 further comprising a ram home sensor adapted to sense that said ram is back in a home position after separating a cardboard box from a skid, pallet, or the like.

11. The system of claim 10 wherein:
said support surface is associated with a plate;
wherein said plate is adapted to rotate downward to eject a skid, pallet, or the like when said ram home sensor senses that said ram is back in said home position after separating a cardboard box from the skid, pallet, or the like.

12. The system of claim 10 wherein:
said support surface is associated with a conveyor system;
wherein said conveyor system is adapted to convey a skid, pallet, or the like such that the skid, pallet, or the like is ejected when said ram home sensor senses that said ram is back in said home position after separating a cardboard box from the skid, pallet, or the like.

13. The system of claim 12 wherein said conveyor system is a roller system.

14. The system of claim 13 wherein said roller system is automatic.

15. The system of claim 10 wherein:
said support surface is associated with an autostacker;
wherein said autostacker is adapted to collect a skid, pallet, or the like when said ram home sensor senses that said ram is back in said home position after separating a cardboard box from the skid, pallet, or the like; and
wherein said autostacker is adapted to stack multiple skids, pallets, or the like that have been collected.

16. The system of claim 15 wherein said autostacker is partially automatic.

17. The system of claim 15 wherein said autostacker is fully automatic.

18. The system of claim 1 wherein said processing system is an auger system.

19. The system of claim 1 wherein said processing system is a ram system.

20. The system of claim 1 wherein said processing system is compactor system.

21. The system of claim 1 wherein said processing system is a conveyor system.
